(19) United States
(12) Patent Application Publication
(10) Pub. No.: US 2009/0265976 A1
(43) Pub. Date: Oct. 29, 2009

(54) Tree snake fence

(76) Inventor: Paul Sampson McLemore, Franklin, TN (US)

Correspondence Address: PAUL SAMPSON McLEMORE, 912 HIGH POINT RIDGE, FRANKLIN, TN, 37069, US

(21) Appl. No.: 12/150,303

(22) Filed: Apr. 28, 2008

(51) Int. Cl. A01M 23/00

(52) U.S. Cl. 43/58; 43/7; 43/124; 43/108

(57) ABSTRACT

The Snake Fence (1), especially for catching snakes. The netting is attached to elastic or non-elastic cord (2) which is wrapped around a tree, tree limb, or any natural or manmade surface. (3) The cord is attached to the netting and the netting is overlapped. (4) It is the single, double, or multiple layering of netting that catches the snakes and holds the snakes. The snakes cannot extricate themselves from the netting. The netting is proportional in size to the snake being caught; the elastic or non-elastic cord is proportional in size to the tree, tree limb, or any natural or manmade surface.

It is the purpose of this invention to catch snakes by incorporating netting and elastic or non-elastic cord of various sizes which are dependent on the size of the snake to be caught. The netting is held by the elastic or non-elastic cord which is fastened to the netting and the netting is wrapped around a tree, tree limb, or any natural or manmade structure. The installation and maintenance is very simple.

### BRIEF DESCRIPTION OF THE DRAWINGS

The invention will now be described in more detail with reference to the drawings whereby:

FIG. 1. The front view of the tree snake fence

FIG. 2. The rear view of the tree snake fence

FIG. 3. The overhead view of the tree snake fence

FIG. 4 The side view of the tree snake fence

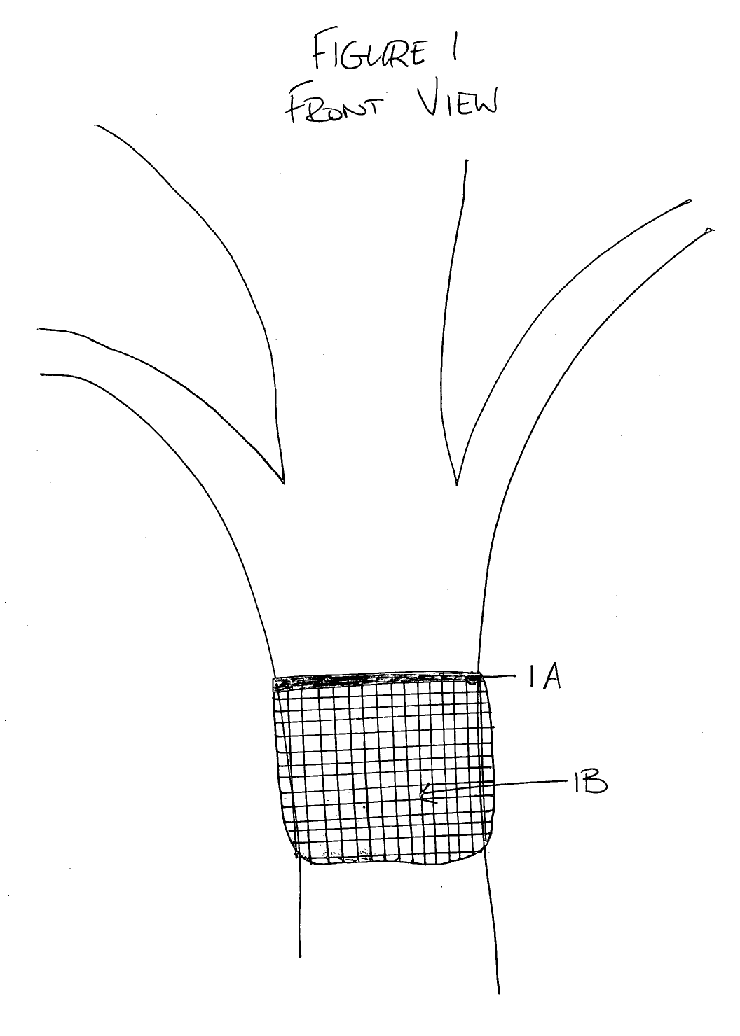

FIG. 1. A. Elastic or non-elastic cord
B. Poly netting

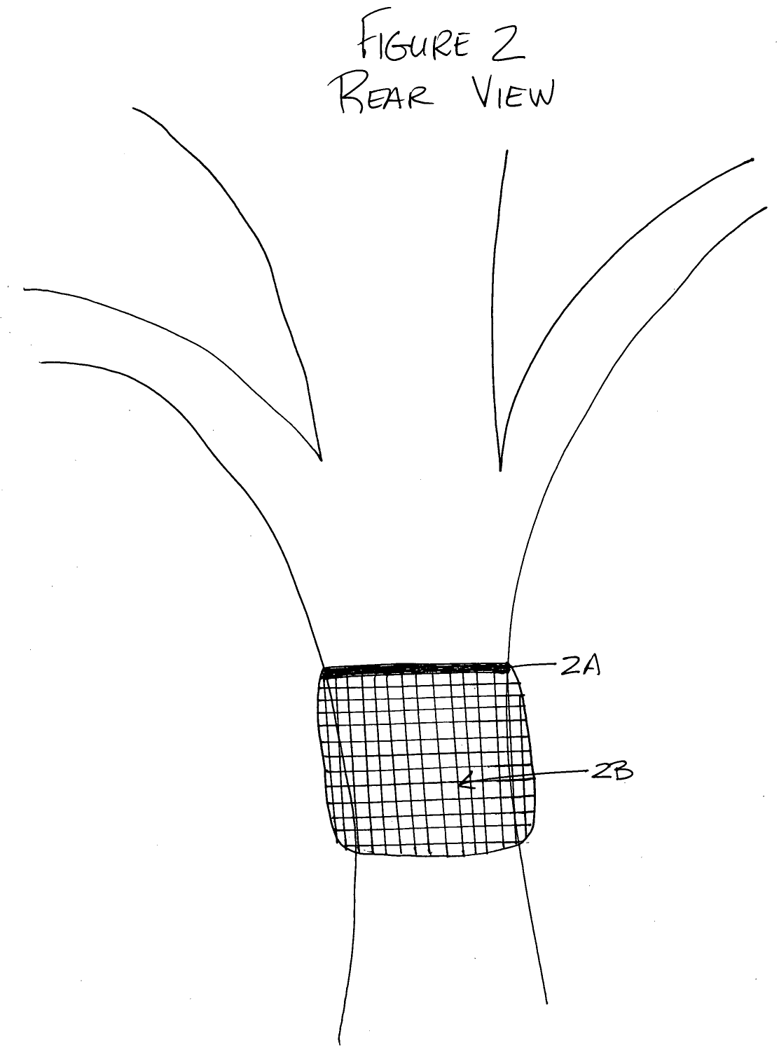

FIG. 2. A. Elastic or non-elastic cord
B. Poly netting

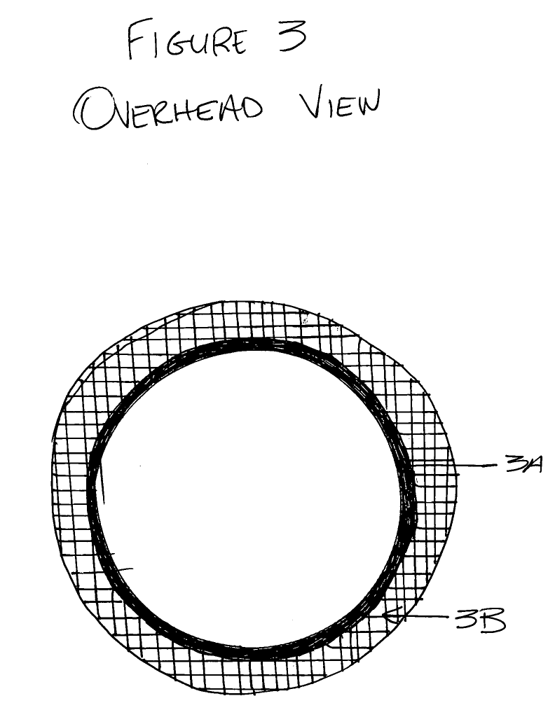

FIG. 3. A. Elastic or non-elastic cord
B. Poly netting

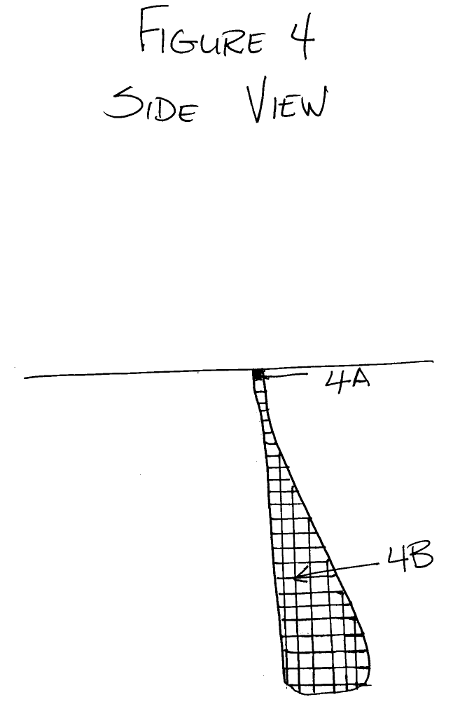

FIG. 4. A. Elastic or non-elastic cord
B. Poly-netting

The invention claimed is:

1. The snake fence for catching snakes is a system of elastic or non-elastic cord and netting that snakes do not avoid crawling through. The opening size of the netting is proportional to the size of the snake it will entrap. The snakes pass approximately one third through the layers of netting before they begin to get trapped. As they attempt to pass through the netting, they continue to get further entrapped as the larger diameter of the snake gets caught in the smaller diameter of the opening of the netting. At some point the snake can no longer pass forward or backward. The scutes (scales on the belly of the snake) helps prevent the snakes from backing out from the netting because the scutes face backwards and the netting catches under the scutes and helps entrap them.

2. The snake fence according to claim 1, wherein said elastic or non-elastic cord affixes the netting and is appropriate to the size of the tree, tree limb, or any natural or manmade surface. The size of the netting is proportional to the size of the snake being caught.

3. The snake fence according to claim 1, wherein said netting is elastic enough to allow the snakes to pass through the opening up to a point and the tensile strength of the netting is strong enough to hold the snake secure when caught.

4. The snake fence according to claim 1, wherein said elastic or non-elastic cord support the netting and secure the netting to the tree, tree limb, or any natural or manmade surface.
